(19) United States
(12) Patent Application Publication
(10) Pub. No.: US 2008/0121699 A1
(43) Pub. Date: May 29, 2008

(54) SELF SERVICE CARD KIOSK WITH RETURN AND REISSUE CAPABILITY

(75) Inventors: Peter THORSEN, Prior Lake, MN (US); Gary KELLER, Minnetonka, MN (US); Harry OLSON, Watertown, MN (US); Patrick S. KRAGTHORPE-SHIRLEY, Minneapolis, MN (US); Lawrence J. COX, Minnetonka, MN (US)

Correspondence Address: HAMRE, SCHUMANN, MUELLER & LARSON, P.C., P.O. BOX 2902, MINNEAPOLIS, MN, 55402-0902, US

(73) Assignee: DATACARD CORPORATION, Minnetonka, MN (US)

(21) Appl. No.: 11/470,880

(22) Filed: Sep. 7, 2006

(51) Int. Cl. G06F 7/08

(52) U.S. Cl. 235/381

(57) ABSTRACT

Improved methods and systems for automated, self-service issuing of a card or other object to an individual. The system can include a self-service issuing machine that is configured to issue a card or object to a user, allow return of the card or object back into the machine, and later reissuing of the card or object to the same or different user. The machine can be used in a number of applications, including with an access control system that controls access into and throughout a building(s). The machine can be configured to dispense temporary re-usable badges to employees, contractors, and visitors. The badges can be returned to the machine, which stores the returned badges for later re-issuance to a later user needing a temporary badge. The machine can also integrate with an enterprise access control system that controls access to a number of dispersed building sites.

### FIELD

This disclosure relates to a self-service machine that issues an object to a user, and allows return of the object for later reissuance to another user. In particular, the disclosure relates to a self-service card issuing machine that is configured to issue a card to a user, allows the return of the card back into the machine, and later reissuing of the card to the same or different user. The machine can be used in a number of applications, including usage with an access control system that controls access into and throughout a building(s).

### BACKGROUND

An access control system is often used to manage access to premises such as building, rooms, laboratories, and building complexes. Persons allowed to enter the premises are provided badges which comprise a machine-readable element such as a magnetic strip, a microprocessor and/or a wireless transponder. Badge readers and automatic doors located throughout the premises that read the badges are connected to the access control system. The access control system maintains a registry of badge identifiers associated with persons such as regular personnel, contractors and visitors, and allows a person access to specific localities of the premises depending on access rights associated with that person's badge.

Many premises assign security personnel or other individuals the task of manning a building entry point, authenticating employees as they enter and/or leave the premises and distributing badges to new employees or current employees who have lost their badges, authenticating and controlling contractor access to the premises, collecting visitor information and entering that information into a permanent record, clearing visitors for entry to the premises and distributing badges to visitors, and other related tasks. Often times, at busy entry points, a number of personnel are needed in order to manage the flow of people. This labor intensive, can lead to security lapses, and can create delays in processing people in and out of the premises. In addition, this method is not effective for premises where there is not sufficient room for a reception area or other entry point, where a plurality of entry/exit points exist, where there are too few employees or visitors to justify assigning an individual to this task, or for operation outside normal working hours.

U.S. Patent Application Publication 2003/0058082 discloses an automated system that is described as being used for providing visitor badges. The described system does not appear to be capable of providing employee badges. In addition, the system appears to lack the capability of allowing the return of, and later reissuance of, the visitor badges.

### SUMMARY

Improved methods and systems for automated, self-service issuing of a card or other object to an individual are described. The card or other object can be returned by the individual for later automated re-issuance of the card or object to the same or different individual. The system can include a self-service issuing machine that is configured to issue a card or object to a user, allow return of the card or object back into the machine, and later reissuing of the card or object to the same or different user.

The machine can be used in a number of applications, including with an access control system that controls access into and throughout a building(s). The machine can be configured to dispense temporary re-usable badges to employees, contractors, and visitors. The badges can be returned to the machine, which stores the returned badges for later re-issuance to a later user needing a temporary badge. The machine can also integrate with an enterprise access control system that controls access to a number of dispersed building sites.

The methods and systems described herein can reduce the amount of personnel needed for use in controlling access to buildings, and can reduce the workload of personnel that are present by allowing people needing a badge to use a self-service machine. Further, the self-service machine can reduce the time spent by employees, contractors and visitors in acquiring and returning the temporary badges. The self-service machine also allows personnel other than designated entry or security point personnel to register, verify identification, obtain and return badges for visitors. In addition, the self-service machine provides a record of badge transactions, leading to more accurate and complete badge security.

### DRAWINGS

FIG. 1 illustrates a perspective view of self-service card issuing machine of the invention.

FIG. 2 illustrates a local access control system using the self-service card issuing machine.

FIG. 3 illustrates the access control system of FIG. 2 integrated with an enterprise access control system.

FIG. 4 is a schematic illustration of the process of dispensing a reusable card.

FIG. 5 is a schematic illustration of the process of a card being returned to the card issuing machine.

FIG. 6 is a top view of the card storage hopper and transport mechanism.

FIG. 7 is a perspective view of the card storage hopper.

FIG. 8 is a front view of the card storage hopper.

### DETAILED DESCRIPTION

Method and systems for automated, self-service issuing of an object to an individual are described in the following description. Objects that can be issued include, but are not limited to, cards and key fobs. Cards include, but are not limited to, badges used for access control to and within buildings or secured areas, debit cards and gift cards. The cards can be, for example, CR80 size cards. The cards are made of materials, for example plastic, that allow the cards to maintain their integrity over repeated uses. To facilitate the description, the inventive concepts will hereinafter be described with respect to the object being a badge used for building access control. However, it is to be realized that the invention concepts apply to issuing other objects as well, and to applications other than access control in a building, for example to machines that issue and receive reloadable objects such as gift cards.

The badges are preferably non-personalized without user specific information, permanent printing or a user photograph added to the badge. Each badge is temporary for a user. The badge is intended to be returned for later automated re-issuance of the badge the same or different individual. The badges are issued by a self-service issuing machine that is configured to issue a badge to a user, allow return of the badge back into the machine where it is stored and later reissued to the same or different user.

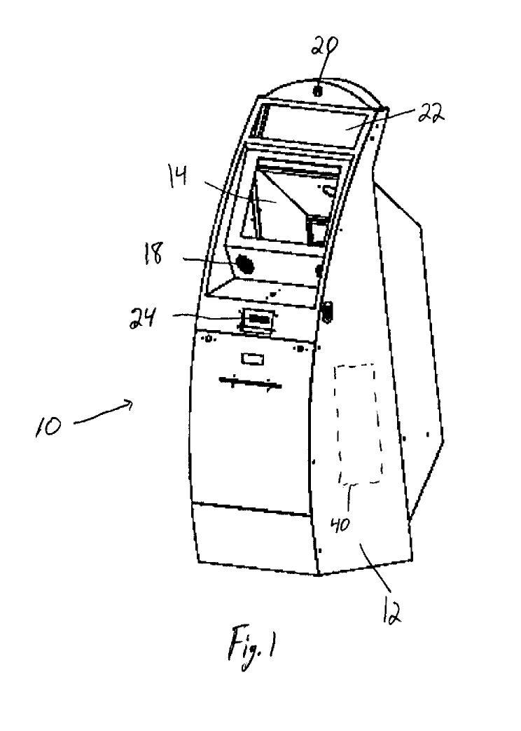

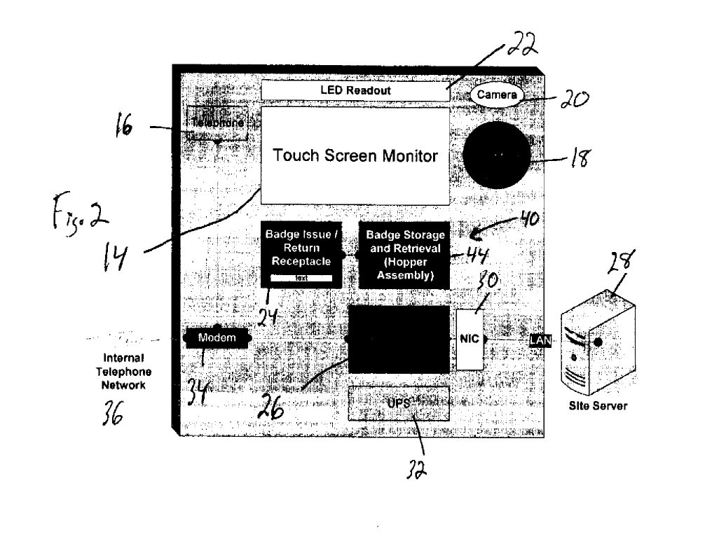

With reference to FIG. 1, a self-service badge issuing machine 10 is illustrated. The machine 10 comprises a housing 12 that includes one or more user interfaces, for example a touch screen monitor 14, accessible from the exterior of the housing 12 to allow a user to interact with the machine 10 and display user prompts and information. The touch screen monitor 14 preferably permits entry of user commands and user data and information. One or more other user interfaces could be used in place of or in addition to the touch screen monitor 14, for example a key board, a mouse, a telephone 16 (shown schematically in FIG. 2), and others.

The machine 10 also includes other exterior components including a speaker 18 to permit audio communications to be communicated to a user, for example by a security person at a security desk, a camera 20 which can take pictures of the user and the machine surroundings which can be stored within the machine 10 and/or relayed to a remote station for viewing or storage, and an LED readout 22 for displaying various messages to the user.

In addition to the above described externally accessible components, the machine 10 includes a badge dispensing/return slot 24, forming a retrieval and return area, through which badges are dispensed to users and returned by users to the machine 10. The slot 24 is illustrated as being in front of the machine 10 beneath the touch screen monitor 14, but could be located at any convenient location on the machine 10.

With reference to FIG. 2, a computer 26 that has a processor, memory for data storage, and a user interface such as a keyboard, is disposed within the interior of the machine 10. The computer 26 is in communication with an external site server 28 via a network interface card 30 and a local area network. The site server 28 can be located in the same building or the same complex of buildings as the machine 10, and contains computer programs and configuration data for operating the machine and a site database containing data on possible users of the machine, such as employee and contractor data. The site server 28 can also control an access control system within the building or complex of buildings. An uninterruptible power supply 32 supplies power to the machine 10 which is plugged into a conventional wall socket via a power cord.

A modem 34 within the machine 10 is connected to the computer 26 and the telephone 16, and is connected to an internal telephone network 36. The modem 34 permits a user to telephone employees or other persons within the building or complex of buildings served by the machine, via the telephone 16 and the internal telephone network 36. Instructions for using the telephone 16 can be displayed on the touch screen monitor 14 along with a list of employees and associated telephone numbers provided via the computer 26 and the site server 28.

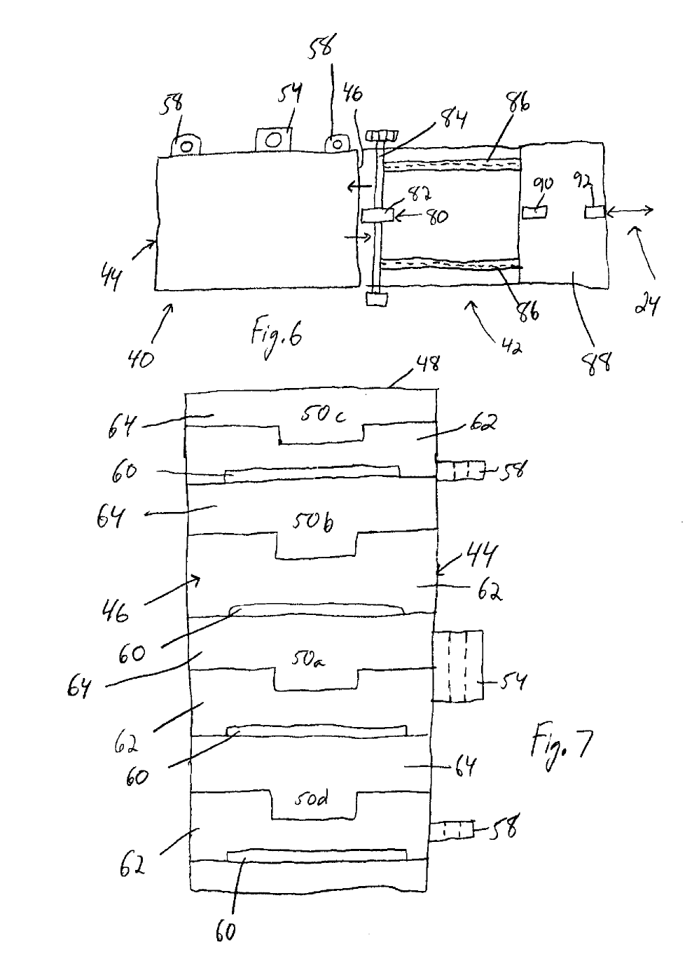

Also internal to the machine is a badge storage area 40 and a transport mechanism 42 (illustrated in FIG. 6). The badge storage area 40 stores badges waiting to be dispensed to a user, and receives badges that are returned by users to the machine 10. The transport mechanism 42 is designed to transport a badge from the storage area 40 to the slot 24 during issuance of a badge, and transport a badge from the slot 24 to the storage area 40 when the badge is returned. The transport mechanism 42 is a two-way transport mechanism in that a badge can be transported in both directions between the slot 24 and the storage area 40. As a result, badges that have been dispensed from the machine can later be returned directly to, and automatically received by, the machine for reuse and reissue of the badges.

With reference to FIGS. 2 and 6-8, the storage area 40 comprises a badge storage and retrieval hopper assembly 44 that is mounted for vertical movement relative to the transport mechanism 42 within the machine. The hopper assembly 44 is designed to discharge cards one at a time through a front side 46 thereof to the transport mechanism 42, and to receive returned cards one at a time through the front side 46 from the transport mechanism 42.

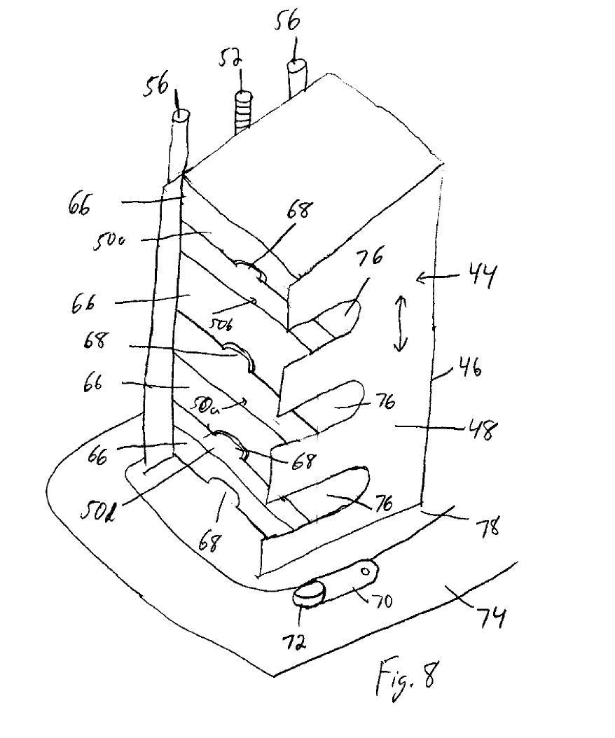

The hopper assembly 44 includes a hopper housing 48 that is configured to hold a plurality of cards. The hopper housing 48 can define a single card storage are or, more preferably, define a plurality of separate card storage locations 50a, 50b, 50c, 50d as shown in FIGS. 7 and 8. The use of separate card storage locations permits the storage of different types of badges to be dispensed. For example, storage location 50a can store employee badges, storage location 50b can store contractor badges, while storage location 50c can store visitor badges. In addition, the hopper housing can include a storage location 50d for rejected cards, including cards that cannot be read by the sensor mechanism (to be later described). If desired, the different types of badges can contain indicia, for example colors, to indicate the different types of badges. For example, an employee badge can be color coded green, a contractor badge color coded blue, and a visitor badge color coded red. Other indicia on the cards to distinguish different types of card can also be used.

The hopper housing 48 is driven vertically be a lead screw 52 that is rotatably driven by a reversible motor (not shown) and a threaded nut 54 that is fixed to the housing 48. A pair of guide posts 56 and slide bearings 58 fixed to the housing 48 that slide on the posts 56 the help guide the housing 48 during its vertical movements.

With reference to FIG. 7 which shows the front side of the hopper housing 48, each of the storage locations 50a, 50b, 50c, 50d includes an exit slot 60 defined in a front wall 62 thereof through which a card from the bottom of the card stack in the storage location exits the storage location when being dispensed. The exit slot 60 has a width that is slightly greater than the width of the cards to allow the cards to travel through the slot 60. Each storage location 50a, 50b, 50c, 50d also includes a return opening 64 generally above the front wall 62 through which a returned card is returned into the storage location to the top of the card stack.

FIG. 8 shows the back side of the hopper housing 48. The back side of each storage location 50a, 50b, 50c, 50d is closed off by a wall 66. A notch 68 is formed at the bottom of each wall 66 thereby exposing the rear edge of the lowermost card in each card stack. A pivotable actuating arm 70 supporting an actuating protrusion 72 is mounted on a stationary structure 74 to the side of the hopper housing 48 and adjacent the back side thereof. In addition, slots 76 associated with each storage location 50a, 50b, 50c, 50d are cut-out in the side of the hopper housing 48. When discharging a card, the actuating arm 70 and protrusion 72 are rotatable into a respective slot 76, with the protrusion 72 engaging the rear edge of the card exposed by the notch 68 to drive the card out the respective exit slot 60 at the front side 46 of the hopper housing 48. For the reject hopper 50d, the arm 70 extends beneath the side wall of the hopper housing instead of rotating into a slot.

The hopper housing 48 is actuatable vertically up and down through an opening 78 in the stationary structure 74 by rotating the lead screw 52 in the appropriate direction. When it is desired to discharge a card from one of the storage locations, for example storage location 50c, the hopper housing 48 is lowered until the exit slot 60 thereof is aligned with the transport mechanism 42. At this position the slot 76 is level with the actuating arm 70. The arm 70 is then rotated to bring the protrusion 72 into engagement with the rear edge of the card exposed by the notch 68 in order to drive the card forwardly into the transport mechanism 42. When it is desired to return a card to the storage location 50c, the hopper housing 48 is lowered until the return opening 64 is aligned with the transport mechanism 42. The transport mechanism 42 then directs the card through the return opening 64 and back on top of the card stack within the storage location 50c for later reissuance.

Returning to FIG. 6, the transport mechanism 42 includes a drive roller assembly 80 that is adjacent the front side 46 of the hopper housing 48. The drive roller assembly is responsible for picking up a card that is driven through one of the exit slots 60 and driving the card toward the discharge slot 24, and receiving returned cards and driving the cards into the respective storage location. The drive roller assembly 80 preferably comprises upper and lower rollers 82 (only the upper roller 82 is shown) mounted on respective drive shafts 84 (only the upper drive shaft 84 is shown) driven by a reversible motor (not shown).

The transport mechanism 42 also includes guide rails 86 that guide the edges of the card. A discharged card is guided by the guide rails 86 to a sensor assembly 88 that includes a sensor for reading a unique identifier on the card. The type of sensor will depend on how the identifier is stored on the card. The unique identifier can be formed by numbers, letters, symbols, pictures, or combinations thereof, a bar code or any other means of forming an identifier that is unique to the card. The identifier can be code or uncoded. The identifier can be disposed in any suitable form on the badge, such as by printing, disposed in a magnetic stripe, disposed in an integrated circuit chip embedded in or on the badge, or attached to a substrate (for example a label) that is attached to the badge. If the identifier is stored on a magnetic stripe of the card, the sensor will be a magnetic stripe reader for reading the magnetic stripe. If the identifier is stored on a chip embedded in the card, the sensor will be a chip reader suitable for reading the chip. If the identifier is stored in bar code form, the sensor will be a bar code reader. Other forms of identifiers and sensors can be used.

The sensor assembly 88 also includes roller assemblies 90, 92 which transport the cards to the discharge slot 24, and receive returned cards through the discharge slot for return to the storage area 40.

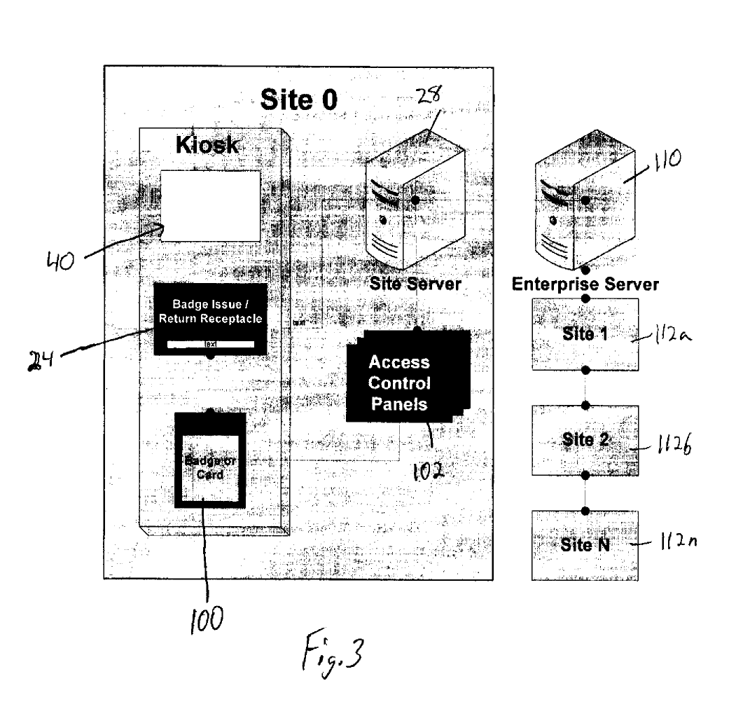

With reference to FIG. 3, an issued card 100 can provide access to the card holder to various locations within the building depending upon the access rights provided to the card holder. The site server 28 can control or be connected to an access control system including a number of access control panels 102 that control access through doorways by reading the card 100. When the card 100 is read, the unique identifier of the card is transmitted back to the site server 28 which, when the card was dispensed, previously recorded that the card was assigned to the card holder by recording the unique identifier with the card holder's name. Depending upon the permissions granted to the card holder by the card access system and site server 28, entry through the door is either granted or denied. At the same time, information on the use of the card can be stored by the site server to record the number of card uses, the door locations, the times of use, etc.

This site server 28 can also be suitably connected to an enterprise server 110 which retains and controls information for a number of distributed sites 112a, 112b, . . . 112n. Each site 112a . . . n would preferably contain at least one of the machines 10 along with a site server.

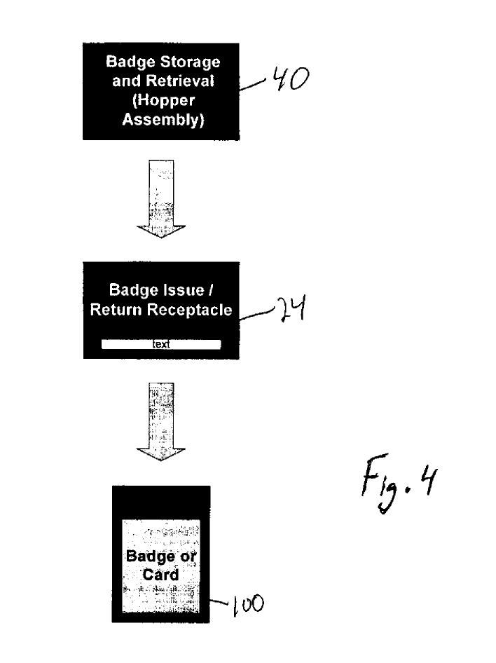

As shown in FIG. 4, a card 100 is dispensed from the machine 10 to a user by discharging a card from the storage area 40, and transporting the card by the transport mechanism 42 to the slot 24. Prior to being dispensed through the slot 24, the unique identifier on the card is read by the sensor of the sensor assembly 88, and the identifier is transmitted to the site server 28 where the identifier is associated with the user who is logged into the machine 10.

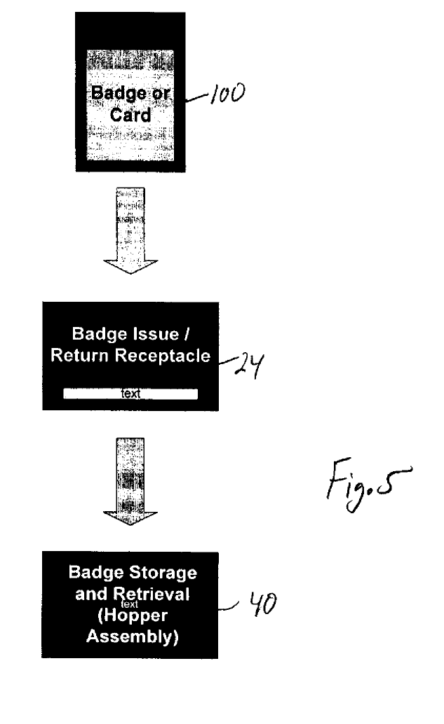

When the card is no longer needed by the user, the user can return the card to the machine 10 by logging on and returning the card through the 24 as shown in FIG. 5. The returned card is picked up by the rollers, and the unique identifier read by the sensor of the sensor assembly 88. In this way, the system knows which card has been returned by which individual and the site server 28 can delete the associated links between the returned card and the user. The returned card is then transported back to the storage area for return into the appropriate location of the hopper housing 48. The returned card can then be dispensed to a new user in need of a badge, with the unique identifier of the card being reassigned to the new user upon dispensing the card. In the case where the unique identifier of the card cannot be read, it is returned to the user. If the user does not take the card within a predetermined amount of time, the card is transported to the reject storage location 50d. In addition, if a user inserts a different form of card that is not recognized by the machine, for example the user inserts a credit card, the machine 10 will withdraw the card back into the machine 10 after presenting the card for the user to pick-up , and direct the card to the reject storage area 50d in order to prevent a later user from obtaining the credit card.

Before issuing a card or returning a card to the hopper housing, the quality of the card is checked by the sensor of the sensor assembly 88. If the card cannot be read, rather than issuing a back card to a user or returning a bad card to the hopper, the card can be directed to the reject storage area.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An apparatus for issuing, allowing return of, and re-issuing an object, comprising:
a housing;
a user interface to enable a user to interact with the apparatus;
a retrieval and return area through which an object is dispensed to and returned by a user;
an object storage area within the housing; and
a transport mechanism that transports an object from the object storage area to the retrieval and return area and from the retrieval and return area to the object storage area to permit issuance of an object from the retrieval and return area and later return of the issued object via the retrieval and return area to the object storage area.

2. The apparatus of claim 1, wherein the object comprises a card, the retrieval and return area comprises a slot in the housing, and the object storage area comprises a card storage hopper.

3. The apparatus of claim 2, wherein the card storage hopper is movable relative to the transport mechanism.

4. The apparatus of claim 1, wherein the user interface comprises a touch screen monitor.

5. The apparatus of claim 1, further comprising one or more of a camera, a speaker, a telephone, and an uninterruptible power supply.

6. The apparatus of claim 1, further comprising a computer disposed within the housing.

7. The apparatus of claim 2, wherein the card comprises a plastic card.

8. A method of issuing a card, comprising:
sorting a card at a first location in a self-service card issuing machine;
issuing the card from the self-service card issuing machine;
receiving the card back into the self-service card issuing machine as a result of the card being re-inserted into the self-service card issuing machine; and
returning the card back to the first location for later re-issuance.

9. The method of claim 8, further comprising re-issuing the card.

10. The method of claim 8, wherein issuing the card and receiving the card back into the self-service card issuing machine occur through the same slot on the self-service card issuing machine.

11. The method of claim 8, wherein the card comprises an employee badge, a contractor badge or a visitor badge.

12. A method of issuing a card from a card issuing machine, comprising:
selecting a card from a card storage area of the card issuing machine based upon user input entered into the card issuing machine, the card having a unique identifier assigned to it;
assigning the identifier to the user;
issuing the card to the user;
upon return of the card to the card issuing machine, returning the card to the card storage area; and
upon additional user input entered into the card issuing machine, selecting the card from the card storage area, reassigning the identifier to the additional user, and reissuing the card to the additional user.

13. The method of claim 12, wherein the card issuing machine is connected to an access control system, assigning the identifier comprises assigning the identifier to the user within a database of the access control system, and reassigning the identifier to the additional user comprises reassigning the identifier to the additional user within the database.

14. A card issuance system, comprising:
a self-service card issuing machine configured to issue cards, allow return of cards back into the machine, and allow reissue of cards that are returned to the machine; and
a site server in communication with the self-service card issuing machine and an access control system.

15. The card issuance system of claim 14, further comprising an enterprise server of an enterprise access control system in communication with the site server and at least one other site server.

16. The card issuance system of claim 14, wherein the site server is separate from the self-service card issuing machine.

17. The card issuance system of claim 15, wherein the enterprise access control system controls access for employees, contractors and visitors.

18. A method of issuing cards, comprising:
providing a self-service card issuing machine that is configured to issue cards, allow return of cards back into the machine, and allow reissue of cards that are returned to the machine;
issuing a card to a user from the self-service card issuing machine; and
receiving a returned card back into the card issuing machine and locating the returned card in a location within the card issuing machine to permit later reissuing.

19. The method of claim 18, further comprising re-issuing the returned card from the self-service card issuing machine.

20. The method of claim 19, comprising assigning an identifier unique to the card to the user, and reassigning the identifier when the returned card is re-issued.

21. A self-service card issuing machine, comprising:
a housing;
a user interface to enable a user to interact with the machine;
means for issuing a card to the user, allowing return of the card back into the machine by the user, and allowing reissue of the returned card.

22. The self-service card issuing machine of claim 21, wherein the user interface comprises a touch screen monitor.

23. The self-service card issuing machine of claim 21, wherein the machine further comprises one or more of a camera, a speaker, a telephone, and an uninterruptible power supply.

24. The self-service card issuing machine of claim 21, further comprising a computer disposed within the housing.
